(19) United States
(12) Patent Application Publication
(10) Pub. No.: US 2003/0201704 A1
(43) Pub. Date: Oct. 30, 2003

(54) Halogen globe light system

(76) Inventors: Richard J. Camarota, Holland, MI (US); Richard Hartmann JR., Holland, MI (US)

Correspondence Address: FLYNN, THIEL, BOUTELL & TANIS, P.C., 2026 Rambling Road, Kalamazoo, MI, 49008-1699, US

(21) Appl. No.: 10/133,309

(22) Filed: Apr. 25, 2002

(51) Int. Cl. H01J 5/48

(52) U.S. Cl. 313/318.01

(57) ABSTRACT

A lamp includes a light emitting unit which has a light source and a generally concave reflector. A light transmitting member is removably attached to the light emitting unit and includes a light reflecting region and a light transmitting region. The lamp includes a collar which has a base that defines a central opening. Positioned in the central opening is a lens. An annular wall surrounds the base and includes first and second rims which extend axially away from an outer edge of the base in opposition to one another. A recess bounded by the first rim is sized to receive an end of the light transmitting member. A recess bounded by the second rim is sized to receive an end of the light emitting unit.

### FIELD OF THE INVENTION

This invention relates generally to a lamp.

### BACKGROUND OF THE INVENTION

Retail businesses, such as restaurants and shops, typically utilize numerous light sources to illuminate public areas. A number of factors can increase the desirability of a light source for use in this setting. For instance, a light source that uses a minimal amount of energy to provide the desired light level is preferable. Standard light bulbs typically fall short in this area since they require relatively high amounts of energy to provide the desired amount of light. The light source must also be easy to change when replacement is necessary. Light sources that are easily changeable by the average employee without the need for special tools are therefore highly desirable. Versatility is also a key feature in a light fixture. Oftentimes, retail establishments, especially restaurants, use varying levels of light for different times of day or for special events.

The assignee of the present application has developed a variety of successful light fixtures over the years. The present invention intends to address the above issues in a continued effort to improve the state of the art.

### SUMMARY OF THE INVENTION

This invention is directed to a new and useful lamp. The lamp of the present invention includes a light emitting unit with a light source. The lamp-includes a light transmitting member and a collar which has a base that supports a lens. An annular wall surrounds the base and includes first and second rims which extend axially away from an outer edge of the base in opposition to one another. A recess bounded by the first rim is sized to receive an end of the light transmitting member. A recess bounded by the second rim is sized to receive an end of the light emitting unit. At least one of the light transmitting member and the light emitting unit is removably attached to the collar.

### BRIEF DESCRIPTION OF THE DRAWINGS

FIG. 1 is a side view of a lamp embodying the present invention;

FIG. 2 is a central cross sectional view of the FIG. 1 lamp substantially as taken along the line II-II;

FIG. 3 is an enlarged fragment of FIG. 2;

FIG. 4 is an enlarged fragment of FIG. 3; and

FIG. 5 is a partially broken sectional view of FIG. 2 taken substantially along the line V-V.

### DETAILED DESCRIPTION

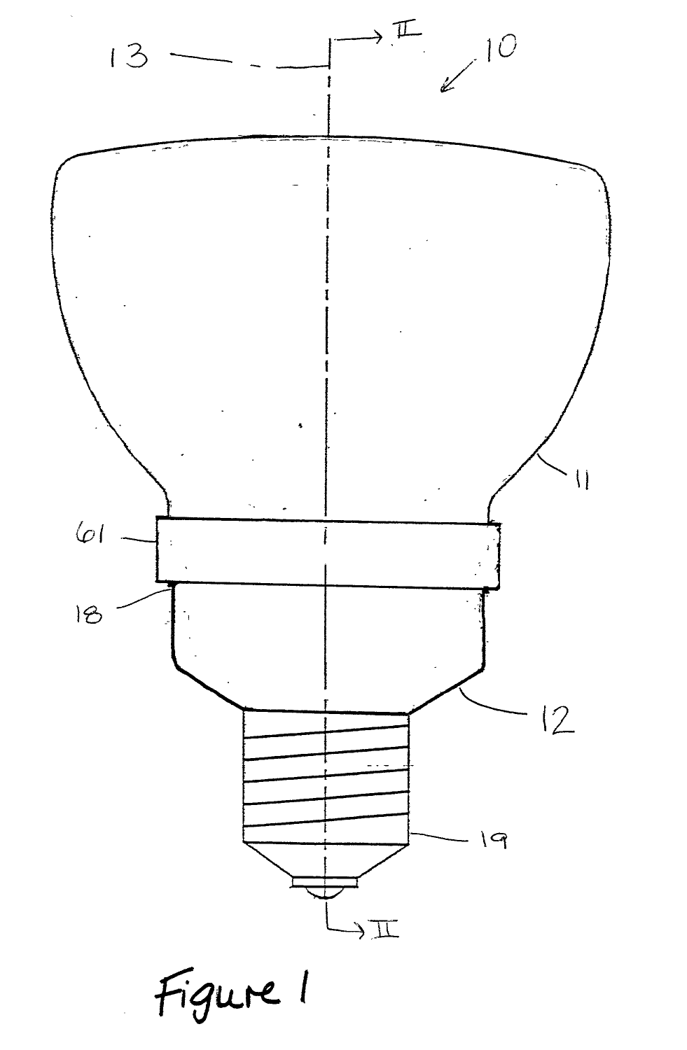

FIG. 1 illustrates a lamp 10 according to the present invention. The lamp 10 includes a light transmitting member 11 and a casing 12 which is removably attached to the light transmitting member 11. The outer profile of the lamp 10 is symmetrical about a central length axis 13.

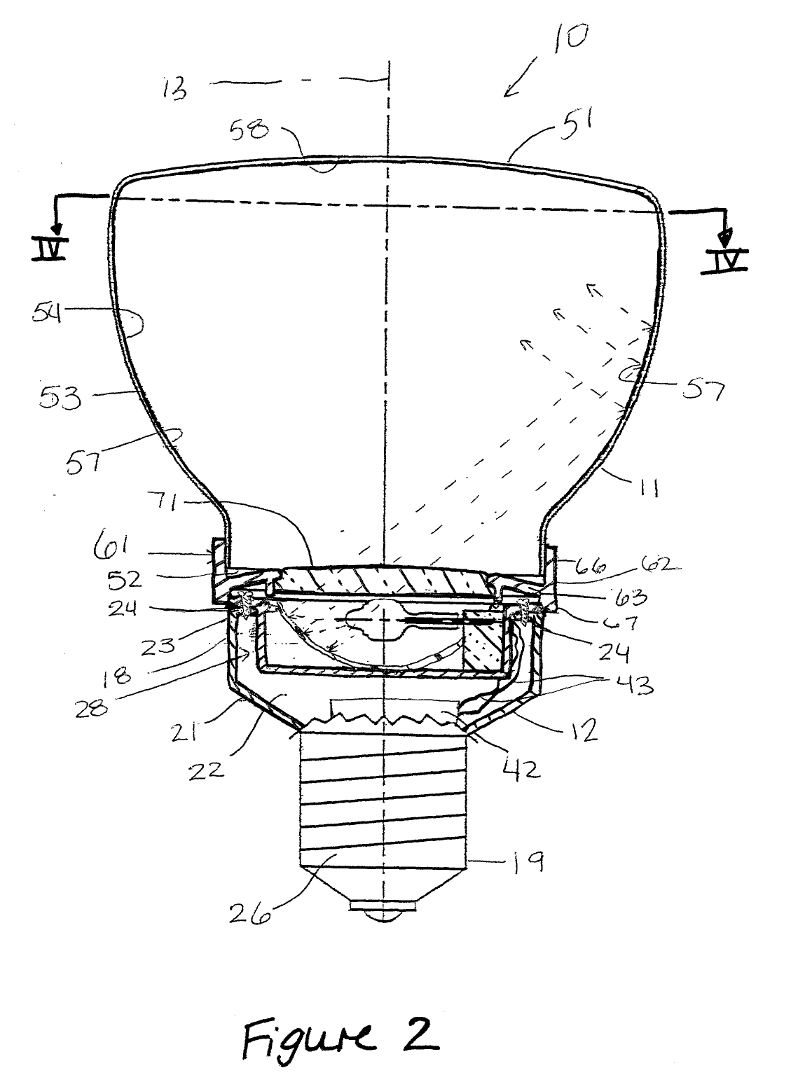

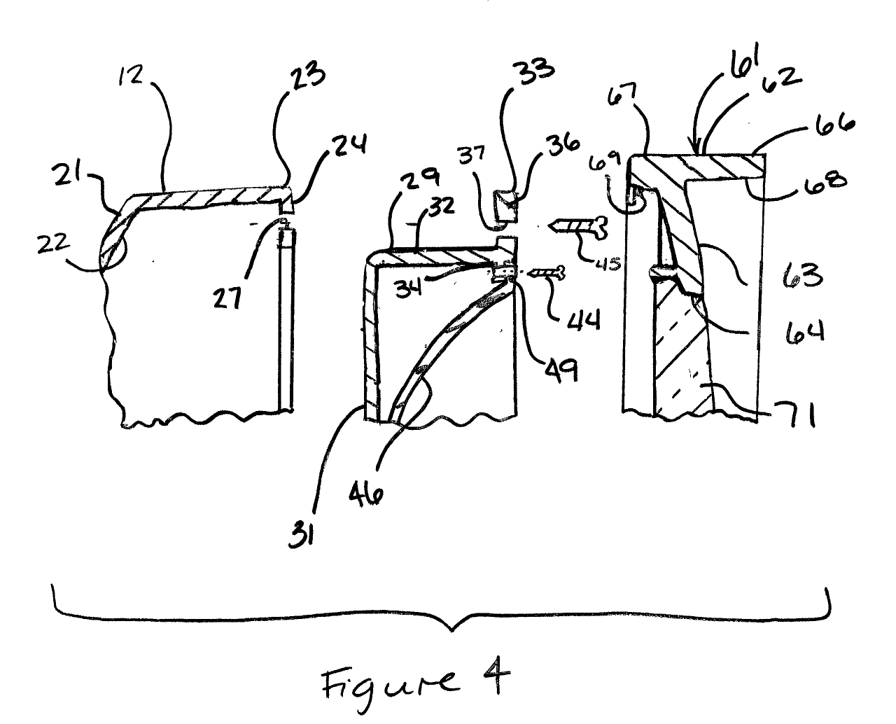

The casing 12 has a relatively large diameter upper end portion 18 and a relatively small diameter lower end portion 19. The upper end portion 18 (FIG. 2) includes an outer wall 21 which surrounds a recess 22. The outer wall 21 has a top end 23 which forms a lip 24 that extends radially inward at the top of the recess 22. At least one hole 27 (FIG. 4) extends through the lip 24. The lower end portion 19 of the casing 12 is hereformed as an externally threaded shell 26 which is configured for installation in a socket (not shown), such as a conventional 120 volt lamp socket. Alternatively, the lower end portion 19 can be configured for installation in a socket of other types.

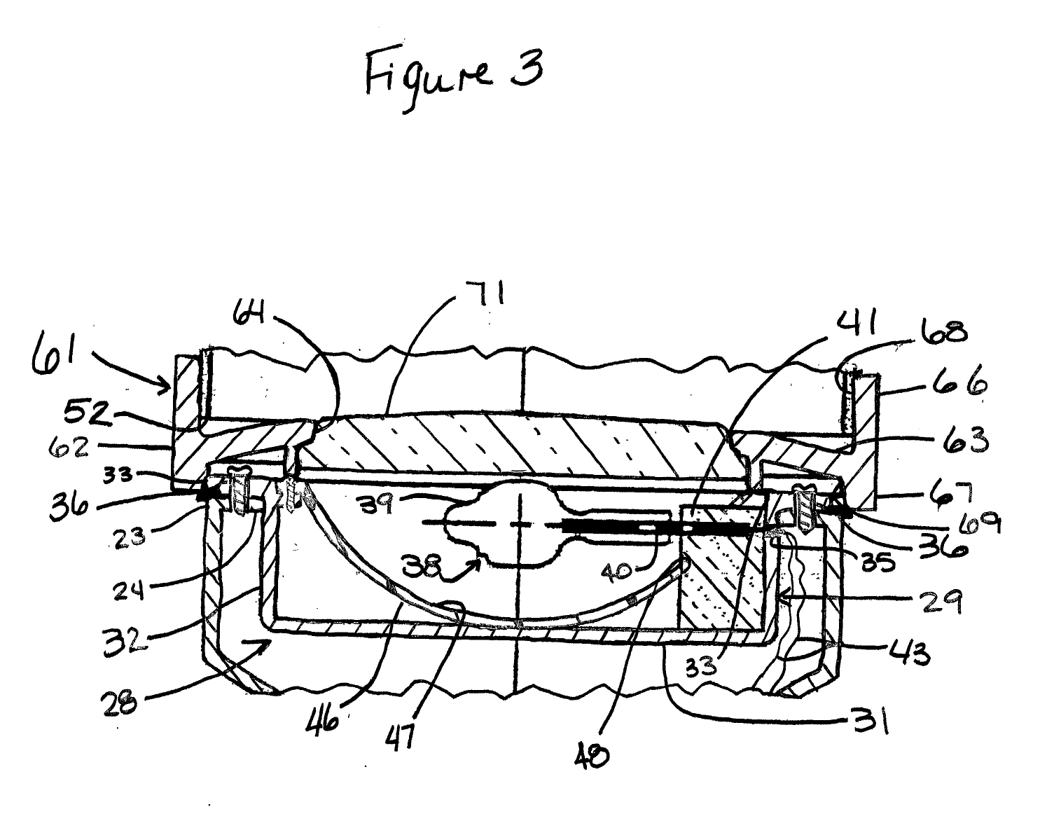

The lamp 10 also includes a light emitting unit 28 (FIG. 3) having a cylindrical cuplike body 29 which is preferably formed from a single piece of material. The body 29 has a circular base 31, a tubular side wall 32 extending upward from the base 31, and a lip 36 which extends radially outward from a top edge 33 of the side wall 32. At least one hole 37 (FIG. 4) extends through the lip 36. A number of tabs 34, one of which is illustrated in FIG. 3, extend radially inward from the top edge 33 of the side wall 32.

The base 31 fixedly contains a conventional socket unit 41 (FIG. 3) and a light source 38, conveniently a halogen bulb. A halogen bulb is preferable for use with this invention because halogen bulbs produce a relatively large light output while being relatively small in size. The bulb 38 conventionally has a light emitting envelope 39 and electrically conductive pins 40. The pins 40 are conventionally fixedly supported in the light emitting unit 28 by the socket unit 41. The socket unit 41 conventionally electrically connects the bulb 38 to a transformer 42 (FIG. 2) via insulated wires 43 which extend through a hole 35 in the body 29.

A reflector 46 (FIG. 3) is fixed in the body 29. The reflector 46 has a generally concave reflective surface 47. The reflector 46 here is a rigid molded plastic element and the surface 47 has a suitable reflective coating. Alternatively, the reflector 46 can be composed of a reflective metal or the like. With a high heat producing light source such as the halogen bulb 38 disclosed herein, the reflector 46 and socket unit 41 are each of a suitable heat resistant material for extended exposure to the hot bulb 38. The reflector 46 is preferably semi-spherical and can have either a smooth or textured surface 47. The reflector 46 includes an opening 48 through which the socket unit 41 extends. A number of wings 49 (FIGS. 3 and 4) extend radially inward from the top edge of the reflector 46.

Returning to FIG. 2, the light transmitting member 11 is a globe, preferably of glass. The globe 11 is of inverted cup-like form with a closed end 51 (upper in FIG. 2) and a contoured, here generally funnel shaped, side wall 53 terminating in an open end 52 (lower in FIG. 2). The inner surface 54 of the globe side wall 53 is covered with a reflective coating, such that the globe side wall 53 is a light reflective region 57 while the globe upper end 51 is a light transmitting region 58. The globe 11 is symmetrical about the central length axis 13.

The lamp 10 includes a circular collar 61 (FIG. 3). The collar 61 includes an axially extending annular wall 62. An annular base 63 angles radially inward from the lower intermediate part of the wall 62 and defines a central opening 64. The wall 62 comprises rims 66 and 67 extending axially from an outer edge of the base 63 respectively axially toward the globe 11 and toward the light emitting unit 28. The rim 66 surrounds a recess 68 and the rim 67 surrounds a recess 69.

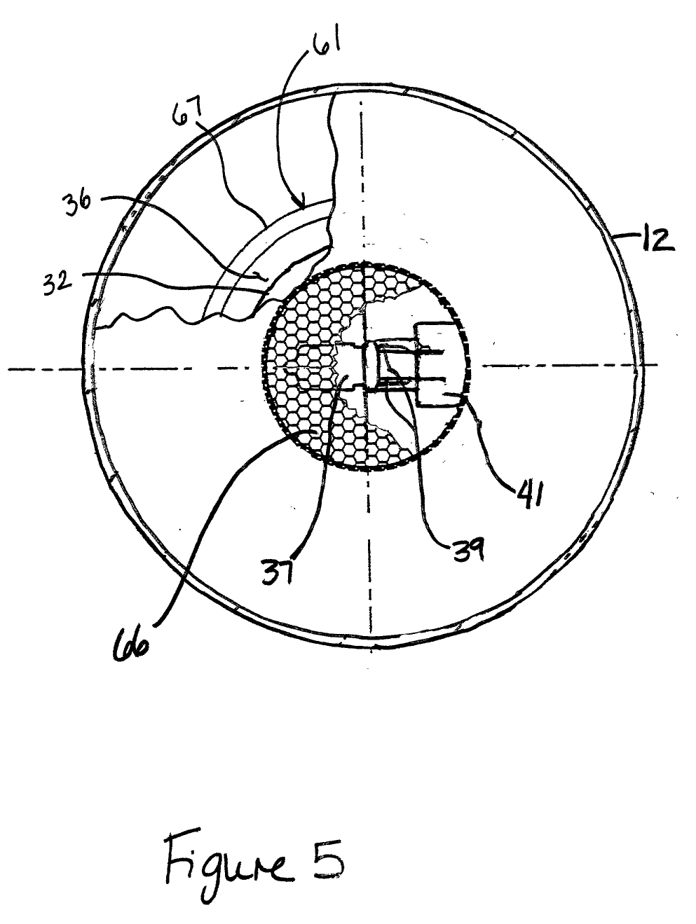

A lens 71 (FIG. 3) is positioned in the central opening 64. The lens 71 is capable of withstanding high amounts of heat and is preferably composed of a silica glass material. The lens 71 can have a textured surface, as illustrated in FIG. 5, or be smooth surfaced. The lens 71 is preferably snap fitted into the opening 64 but can be fixed more permanently therein by a suitable adhesive.

High pressure halogen bulbs can explode under certain circumstances. Therefore, any lamp having a high pressure halogen bulb as its light source must include a containment barrier to prevent the bulb from exploding out into the atmosphere should an explosion occur. In conventional halogen lamps, the containment barrier is in the form of a thick, heavy outer lens. In the lamp disclosed herein, the lens 71 forms a sufficient containment barrier while still allowing the lamp to have a highly transmittent outer globe, which is more aesthetically pleasing, smaller and lighter than the outer coverings of previous halogen lamps.

To assemble the lamp 10 of the present invention, the light emitting unit 28 is first assembled. The reflector 46 is secured in the body 29 so the wings 49 are positioned over the tabs 34 of the body 29 and the socket unit 41 extends through the reflector opening 48. Fasteners 44 (FIG. 4), such as the screws illustrated herein, fix the reflector wings 49 to the tabs 34 to secure the reflector 46 to the body 29. The bulb 38 is then secured in the light emitting unit 28 by conventionally inserting the pins 40 into the socket unit 41.

The transformer 42 is conventionally secured in the casing recess 22. The wires 43 are then connected to the transformer 42 to electrically connect the socket unit 41 to the transformer 42. The light emitting unit 28 is then seated in the casing 12 so the body lip 36 is positioned on top of the casing outer wall lip 24. The body 29 is secured to the casing 12 by one or more screws 45 (FIG. 4) which are threaded through the holes 27 and 37 in the lips 24 and 36, respectively.

To complete assembly of the lamp 10, the globe open end 52 is inserted into the recess 68 bounded by the rim 66. The globe end 52 is secured thereto by a suitable adhesive, such as a silicone glue. The collar 61 is then positioned over the light emitting unit 28 so the rim 67 is positioned over the lip 36. The collar 61 is twisted to lock the light emitting unit 28, and thus the casing 12, thereto. The twist locking interaction between the collar 61 and the lip 36 can be formed from complimentary bayonet locking features on these components, from a complimentary thread arrangement or by another suitable arrangement.

### Operation

To use the lamp 10 of the present invention, the shell 26 is tightened into a light socket. When the lamp 10 is activated, the bulb 38 emits light from within the lamp 10. That portion of light which is directed back into the body 29 is reflected outward by the reflector 46, as schematically illustrated in FIG. 2. Light emitted within the lamp 10 is further reflected by the reflective region 57 of the globe side wall 53 so that a majority of light emitted by the bulb 38 is transmitted through the globe closed end 51, as schematically illustrated in FIG. 2. This feature allows the lamp 10 to project light in a single direction.

Since the light source 38 utilized by the present invention is a halogen bulb, the lamp 10 utilizes less wattage than a standard bulb. When desired, the halogen bulb 38 of the present lamp 10 can be dimmed, such as by a conventional dimmer switch. In addition, the lens 71 will absorb a majority of the heat produced by the halogen bulb 38. Therefore, the thin walls of the glass globe 11 will not be exposed to the full amount of heat produced by the bulb 38. Further, since lens 71 is a suitable containment barrier, the lamp 10 can include an outer globe which is aesthetically pleasing, as well as being smaller and lighter than previous halogen lamp outer coverings.

When the halogen bulb 38 burns out, it is easily changed without the need for special tools. To change the bulb 38, the lamp 10 is twisted to disengage the shell 26 from the socket. The collar 61 is then twisted so that it is unlocked from the light source body 29. Once the collar 61 is loosened, the globe 11 and collar 61 are lifted away to expose the bulb 38. The spent halogen bulb 38 is then removed by disengaging the pins 40 from the socket unit 41. A new bulb is installed by conventionally inserting the pins into the socket unit 41. The globe 11 and collar 61 are then reattached to the light emitting unit 28 and the casing 12 by tightening the collar 61 about the lip 36 of the light source body 29. Once reassembled, the shell 26 is returned to the socket and the lamp 10 can once again provide the desired light.

It should be appreciated that the foregoing description is for the purpose of illustration only, and further alternative embodiments of this invention are possible without departing from the scope of the claims. For instance, the collar and light source body could instead be secured to one another by a snap lock or by a complimentary threaded arrangement. Further, the light transmitting member could be secured to the collar in a removable manner, similar to the light source body, rather than in the permanent manner disclosed.

Thus, although particular preferred embodiments of the present invention have been disclosed in detail for illustrative purposes, it will be recognized that variations or modifications lie within the scope of the present invention and do not depart from the spirit of the invention.

What is claimed is:

1. A lamp comprising:
a light emitting unit having first and second ends and including a light source and a generally concave reflector;
a light transmitting member having first and second ends and including a light reflecting region and a light transmitting region;
a collar including an outer wall which surrounds a base having a central opening;
a lens positioned in said central opening;
said collar outer wall including first and second rims which extend axially from an outer edge of the base in opposition to one another;
said first rim surrounding a first recess and said second rim surrounding a second recess; and
said first end of said light transmitting member being received in said first recess and said first end of said light emitting unit being received in said second recess, wherein at least one of said light transmitting member first end and said light emitting unit first end is removably secured in said respective recess.

2. The lamp according to claim 1 wherein said light transmitting member first end is permanently attached to said first rim in said first recess; and
said light emitting unit first end is removably attached to said second rim in said second recess.

3. The lamp according to claim 1 wherein said light emitting unit includes a body having an outer wall;
said outer wall includes a lip; and
said light emitting unit is attached to said collar by a twist-locking interaction between said outer wall lip and said second rim.

4. The lamp according to claim 3 wherein said light transmitting member first end is secured to said first rim in said first recess by an adhesive.

5. The lamp according to claim 1 wherein said light transmitting member is a glass globe having a contoured side wall; and
a reflective substance is applied to an interior surface of said side wall to form said at least one light reflective region.

6. The lamp according to claim 1 wherein said light source is positioned between said reflector and said lens.

7. The lamp according to claim 1 wherein said light source is a halogen bulb.
